(19) United States
(12) Patent Application Publication
(10) Pub. No.: US 2010/0198506 A1
(43) Pub. Date: Aug. 5, 2010

(54) Street and landmark name(s) and/or turning indicators superimposed on user's field of vision with dynamic moving capabilities

(76) Inventor: Robert Steven Neilhouse, Fort Smith, AR (US)

Correspondence Address: Robert S. Neihouse, 5413 Catina Court, Fort Smith, AR, 72916, US

(21) Appl. No.: 12/322,427

(22) Filed: Feb. 3, 2009

(51) Int. Cl. G01C 21/26

(52) U.S. Cl. 701/208

(57) ABSTRACT

The invention provides for street and/or landmark name(s) to be displayed or projected on, behind or in front of a window or windshield of a vehicle or the surface of a pair of eyeglasses and in a manner such that the user (e.g. driver) does not have to turn his head or move his eyes from the path in front to see the information. The invention uses the estimated location of the user's eyes to determine where to project or display the street and/or landmark name(s) and/or turning indicator such that the name(s) and/or indicator appear to be displayed at the perceived location of the street(s) or landmark(s) in question. The name(s) and/or turning indicator appear to move with regard to the user's perspective as the location of the street(s) and/or landmark(s) move across his field of vision such that name(s) and/or indicator appear to remain stationary and attached the street(s) and/or landmark(s) as the vehicle moves.

### SPECIFICATION

Throughout the body of this patent application the term “street” shall refer to any street, road, highway, interstate, avenue, boulevard, passage, rail tracks, trail or any other recognized name for a passage either by foot, rail, bike, automobile or any other mechanized or non-mechanized form of transportation.

Throughout the body of this patent application the term “vehicle” shall refer to any automobile, truck, train, airplane, trailer, wagon, bicycle, boat, ship, motorcycle, tractor or any other form of transportation either mechanized or non-mechanized.

Throughout the body of this patent application the term “user” refers to the person or persons using the invention for the purposes intended. This includes (but is not limited to) the driver or any passenger of any vehicle.

### TITLE OF THE INVENTION

Street and Landmark Name(s) and/or Turning Indicators Superimposed on User's Field of Vision with Dynamic Moving Capabilities

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE OR A COMPUTER PROGRAM LISTING COMPACT DISC APPENDIX

Not Applicable

### BACKGROUND OF THE INVENTION

Navigational data provided by GPS systems or other means has typically been displayed on a screen somewhere out of the line of sight of the user's (e.g. driver's) immediate field of vision. This forces the user to either move his eyes or turn his head (or both) in order to view the navigation information. In doing so, a driver becomes vulnerable and susceptible to a dangerous lapse of awareness of the path in front of him. Further, information on where to turn can be provided on this separate screen or even by audible indications (such as announcing the street name and which direction to turn) but the user (e.g. driver) often has difficulty determining which street is the correct one on which to turn. This is particularly true if there are many streets within the field of view and/or if there is no street name displayed or the street name is difficult to find or see (e.g. at night with no street lights).

To prevent the lapse in awareness the invention displays street and/or other landmark name(s) on, behind or in front of a window or windshield or on the surface of a pair of glasses by means of projection, embedded LCD, Heads-Up display or any known or as-yet undiscovered means for displaying graphical and/or alpha-numeric information to the user in a manner such that the information appears to be superimposed or overlaid upon or near objects (e.g. streets or landmarks) in the user's field of vision. The invention is further extended to indicate multiple street and landmark names displayed simultaneously for the benefit of the user's general understanding of the terrain.

The invention displays street and/or landmark name(s) and graphical information using either simple, thin, non-obtrusive lines or as larger translucent lines overlaid at or near the perceived positions of the turn and/or street and/or landmark name(s) so as not to significantly obstruct the user's view. The focus, size and perspective of the text and graphics is adjusted so as to appear to be the same distance and angle as the target street or landmark.

The displayed graphical and alphanumeric information (here also to include a turning indicator or arrow) is overlaid at or near the perceived location(s) of the street(s) and/or landmark(s) in question with regard to the user's perspective so that, when viewed by the user, the street and/or landmark name(s) and/or turning indicator and other associated graphics appear to be at or near the location of the street(s) or landmark(s) giving the perception that name(s) and/or indicator appear to be attached to and/or in or on the street(s) and/or landmark(s) in question. For example, street names could (among other means) be specified with the use of a leader—a line pointing to the street at one end with the name of the street (perhaps in a text box) at the other end.

Displaying the street and/or landmark names and/or turning indicator at their perceived correct location(s) in the user's field of vision requires information about the relative location of the user's eyes (when eyeglasses are not used to project or display the image). Determining the location of the user's eyes can be performed by any of a variety of calibration procedures before the device is rendered useable (for reasons of accuracy and safety). This location information can be stored electronically (or otherwise) and tied to a given user so that it can be immediately retrieved the next time that user sits in that same location. Other mechanisms can also be used to determine the location of the occupant's eyes including (but not limited to) face-detection technology.

Finally, the street and/or landmark name(s) and/or turning indicator will appear to be affixed to the street(s) or landmark(s) in question so that, as the vehicle moves through time and space, the names and graphical indicators displayed or projected move with regard to the user's perspective as the location of the street(s) and/or landmark(s) move in the user's field of vision such that the names and graphical indicators appear to be stationary and affixed to the street(s) and landmark(s) outside the vehicle.

### BRIEF SUMMARY OF THE INVENTION

The invention displays navigation turning direction indication information (e.g. an arrow) and/or street and/or other landmark name(s) to the user (including but not limited to the driver) on, in front of or behind a window or windshield and in the line-of-site of the user instead of on a separate screen (normally out of the line-of-site) so that the user need not move his eyes or head (or both) from the viewing the street or passage in front of him. The invention imparts to the user (by adjustment of focus and perspective of the text and graphics) an optical illusion that the street and/or landmark name(s) and/or turning direction indicator are fixed to the street(s) and/or landmark(s) outside the vehicle. Further, the invention allows for the street and/or landmark name(s) and/or turn direction indicator to move dynamically across or through the field of vision of the user so that the name(s) and/or direction indicator appear to be fixed to the street(s) and/or landmark(s) in question and do not (for all practical purposes) appear to the user to move from the street(s) and/or landmark(s) in question.

### BRIEF DESCRIPTION OF SEVERAL VIEWS OF THE DRAWING

FIG. 1: One method for calibrating the invention. In this diagram, the device is calibrated by fixing a secondary device with cross-hairs to a fixed location on the front of the vehicle (e.g. on the hood or front bumper) within the user's field of view (A). A second set of cross-hairs (B) is displayed electronically at or near the windshield. The driver moves the second set of cross-hairs (by use of keys on the steering wheel or similar) until both sets of cross-hairs line up. The forward adjustment of the driver's seat is sensed electronically and a location is calculated for the position of the user's eyes in all three dimensions.

FIG. 2: Display of street and/or landmark name(s) and turn indicator to give the user of the invention the illusion or perception that the name(s) and turn indicator are printed (painted) on or near (in the space around) the street(s) and/or landmark(s) in question.

Item A in this figure is the windshield which (for all intents and purposes) bounds the driver's field of vision. Item B is the steering wheel.

In this example, Main, Maple and Birch streets are displayed superimposed (from the driver's perspective) over the physical streets they represent. Further, the text “MAIN STREET” appears to be written directly on the street while Birch and Maple street are each called out with the use of a leader and text box. A left turn indicator (arrow) is shown and a restaurant (Joe's Restaurant) is also called out as a landmark within the driver's field of vision. Thus, multiple landmark(s) and street name(s) along with a turn direction indicator (arrow) are displayed simultaneously and are all superimposed on or near the objects they represent from the driver's perspective.

FIG. 3: Motion of street and/or landmark name(s) and/or turn indicator through the field of vision as viewed by the user of the invention. The movements of the street and/or landmark name(s) and/or turn indicator give the illusion to the user that the name(s) and/or turn indicator are affixed to the street(s) and/or landmark(s) outside the user's vehicle.

Item A in this figure is the windshield which (for all intents and purposes) bounds the driver's field of vision. Item B is the steering wheel.

In this example, Elm street first comes into the driver's field of vision at time T and the name of the street appears superimposed over the actual street (in focus at the distance of the street with perspective altered to match the perspective of the street from the driver's point of view). At time T+1 there is enough room to display a turn direction indicator (arrow) as the route requires a right turn on Elm street. At time T+2 Elm street has moved significantly down and to the right side of the driver's field of view. Yet, the text “Elm street” and the arrow still appear to be superimposed over Elm street. The text and arrow have moved in the driver's field of vision with Elm street as the street moves through the driver's field of vision. This gives the illusion to the driver that the text and arrow are actually painted on the street. Also at time T+2, a second street; Oak street, comes into the driver's field of vision. At this point the invention also displays the text “Oak street” simultaneously with Elm and Main Street and the right-turn arrow. All appear to be attached to (and moving with) their respective physical streets from the driver's perspective.

### DETAILED DESCRIPTION OF THE INVENTION

Text, turning direction indicators and other navigation information can be displayed on, in front of, or behind any window or windshield to aid occupants (e.g. the driver) in navigation. Achieving the display can be by any of various known or as-yet undiscovered methods including (but not limited to) embedded Liquid Crystal Display (LCD) technology (in the windshield itself, any of various projection technologies or Heads-Up display technologies as examples. The proposed projection may take place anywhere inside or outside the cabin area. Examples of projection locations could be (but are not limited to) the dashboard, the hood, the ceiling or headliner and etc. The invention uses information from a GPS (or other) navigation system and other parameters to determine:
1. The location of the vehicle,
2. the distance from the vehicle to any street or landmark within the field of view,
3. the distance from the vehicle to a given turn in the field of view,
4. elevations of items 1-3,
5. the angle and perspective between the driver and a given object in the field of view (such as a street).
6. the height and width of the projection area (a known parameter for any given vehicle),
7. the approximate horizontal and vertical position of the occupant's eyes relative to a fixed point on the vehicle,
8. Speed and direction of the vehicle.

With this information, the location of a given street, landmark or turn within the user's (driver's) field of vision (normally bound by the borders of the windshield) can be determined and displayed such that the street(s) and/or landmark name(s) and/or turning direction indicator (e.g. an arrow) (as necessary) appear to be displayed (from the user's perspective) at the same location as the street. For example, the name and arrow could almost appear to be printed (painted) on the street from the user's (driver's) perspective.

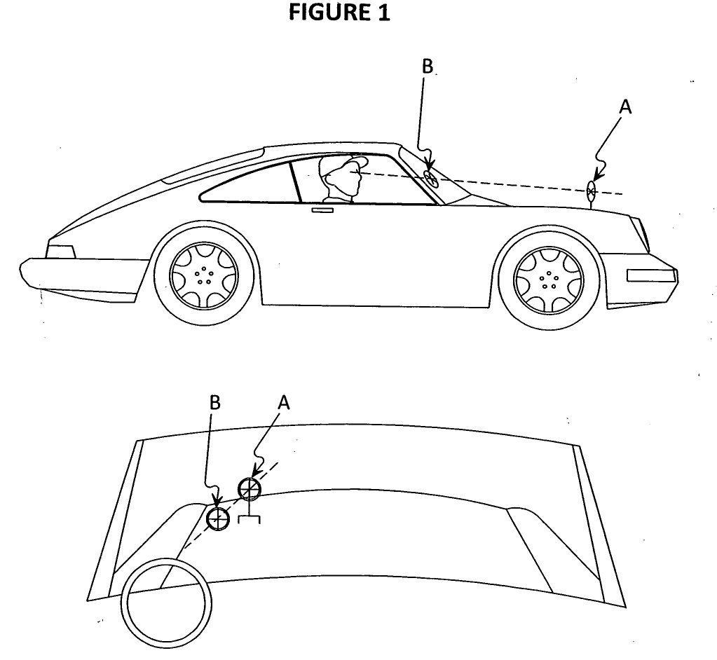

To determine item 7 above, a calibration procedure will need to be performed for every perspective user (e.g. driver) that could utilize the invention (except in the case where eyeglasses are used to project or display the image). The method for calibration (or determining the position of the eyes) is not part of this patent application and could involve any of a variety of methods including Face-Detection Technology. For the sake of example a proposed method of calibration is noted in FIG. 1. In this example two sets of crosshairs are lined up by the driver while he sits in the driver's seat. By determining the following three items, the position of the eyes in all three dimensions can be determined:
A. The fixed location of crosshairs at position 1.
B. The variable location of crosshairs at position 2.
C. The distance from the driver's head to the windshield (in this case determined by the forward adjustment of the driver's seat).

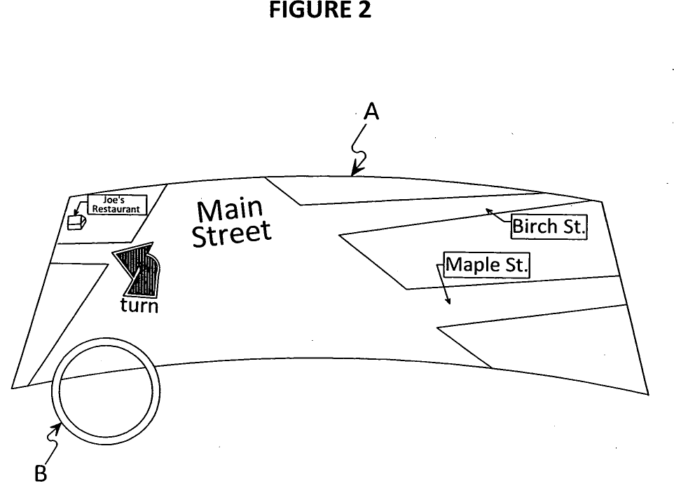

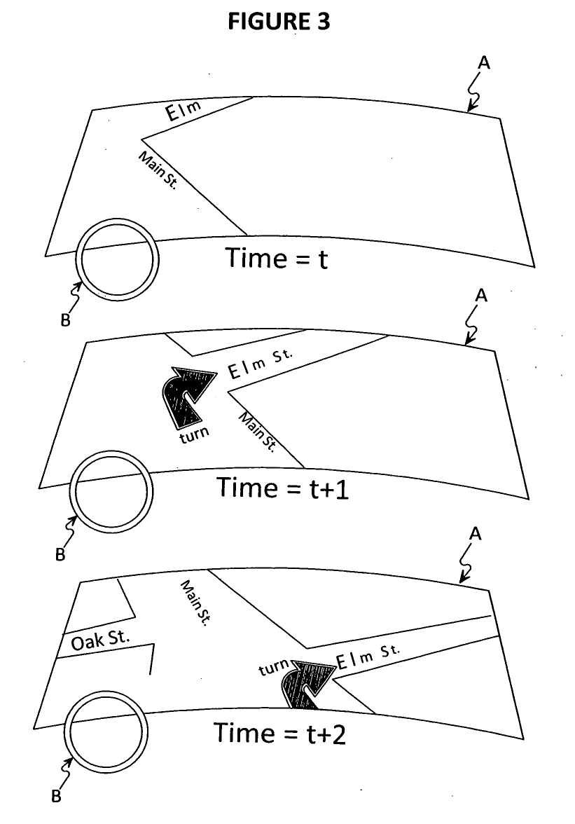

With items 1 through 8 above known, the street and/or landmark name(s) and potential turn indication within the user's field of view can be displayed so that it appears to the user that the street and/or landmark name(s) and turn direction indicator (arrow) are actually displayed on or near (e.g. in the space around) the street. This is done in a virtual sense such that only the user in the vehicle in question correctly perceives this information. It will likely not be properly sensed by persons outside the vehicle and those inside the vehicle other than the user may perceive some of the information but it may not be correct from their perspective. The relative display of street and/or landmark name(s) and/or turn direction indicator superimposed in the field of vision such that the name(s) and/or indicator appear to be displayed on the street(s) and/or landmark(s) or in the space(s) near the street(s) and/or landmark(s) is one of the major claims of this patent application. FIG. 2 gives some sense of this.

As the vehicle in question moves through space and time, the street and/or landmark name(s) and turn indicator (if applicable) within the field of view will appear to the user to be stationary with the street(s) and/or landmark(s) to give the illusion to the user that they (name(s) and turn indicator) are affixed to the street(s) and/or landmark(s) (stationary with respect to the environment outside the vehicle). This is one of the major claims of this patent application and is very important to the user. The dynamic motion of street and/or landmark name(s) and/or turn indicator either across or up or down the user's field of vision as the vehicle moves through space and time will take place such that it appears (or virtually appears) to the user as though the projected name(s) and turn indicator are printed (painted) on the street(s) and/or landmark(s) or near (in the space around) the street(s) and/or landmark(s). FIG. 3 gives some sense of this.

As noted prior, multiple street and/or landmark name(s)—perhaps for all streets and landmarks within the field of view can be displayed and dynamically moving in different directions simultaneously as the vehicle moves through space and time to give the illusion to the user that multiple street and/or landmark names are moving with, and appear to be attached to, the respective street(s) and/or landmark(s) in question. The dynamic motion of multiple street and/or landmark identities and possible turn indicator simultaneously displayed is also a major claim of this patent application. Each street and/or landmark is assigned specific coordinate and vector information to determine the new location of the name(s) and/or turn indicator displayed at the next point in time at regular preset intervals determined by the necessity to update the display in order to appear seamless to the user or the computational capacity of the computer or processor used to calculate the data or both.

The invention also displays street and/or landmark name(s) and/or turn indicator(s), leaders, text boxes, tags and/or etc. as necessary with very thin lines—so thin as to not obstruct the user's view or interfere significantly with navigation of the vehicle. The graphical and/or alphanumeric data can also be displayed with translucent properties so as not to interfere significantly with navigation of the vehicle.

The embodiments of the invention in which an exclusive property or privilege is claimed are defined as follows:

1. The display of street and/or other landmark name(s) on, behind or in front of the surface a pair of eyeglasses, a window or a windshield using any conceivable means such as (but not limited to) projectors (of any sort), embedded dynamic displays (translucent or otherwise)(such as Liquid Crystal Display (LCD)) or Heads-Up technology. The display of such information in this manner is specifically intended to prevent the user of the invention (especially a driver) from needing to look away from the course ahead to determine street and/or landmark names as these will now be displayed directly in the driver's line of site to the path ahead.

2. The display of street and/or or other landmark names and/or potential future or past (missed) turn direction indicator(s) on, behind or in front of the surface a pair of eyeglasses, a window or a windshield using any conceivable means (see claim 1 for examples) to overlay or superimpose or otherwise display or specify the street and or landmark name(s) and/or potential future or past (missed) turn direction indicator(s) directly over, near or around the apparent space of any given street or landmark as perceived by the user of the invention. The text and associated graphics displayed will have perspective and focus adjusted so as to appear to be at or near the location of the street or landmark in question. From the user's perspective, focus and perspective of the text and graphics are adjusted so that the street and/or landmark name(s) and/or potential future or past (missed) turn direction indicator(s) will appear to be in the space around or near any portion of the street(s) or landmark(s) in question or will appear to be written directly on or near the street(s) or landmark(s) in question. This display will be an optical illusion seen by the user of the invention and (perhaps) others inside the vehicle. Persons outside the vehicle may not properly perceive the information as such. Further, the superimposed street and/or landmark name(s) will prevent unnecessary searching of the user for the displayed name of the street or landmark on a physical sign outside the vehicle which may or may not be present or may be difficult to find or see for various reasons.

3. The dynamic movement of one or more of the street and/or other landmark names mentioned in claim 2 and/or the potential future or past (missed) turn indicator (e.g. an arrow) mentioned in claim 2 across the user's field of vision so as to appear fixed to the street(s) and/or landmark(s) in question outside the vehicle of the user of the invention as the vehicle moves through space and time. The text and associated graphics displayed will have perspective and focus continuously adjusted so as to appear to be at or near the location of the street or landmark in question at all times. The dynamic moving nature of the name(s), turn indicator or etc. across the user's field of vision gives the user of the invention the perception or illusion that the name(s) and/or turn indicator are stationary and affixed to the street(s) and/or landmark(s) in question outside the vehicle as the vehicle traverses through space and time. This claim is for a single name or graphic object or for multiple name(s) and/or graphic object(s) displayed simultaneously and moving in different directions and speeds through the user's field of view (i.e. it is not limited to single object moving in a single direction or multiple objects moving in a single direction across the user's field of vision).
